(19) United States
(12) Patent Application Publication
(10) Pub. No.: US 2015/0250674 A1
(43) Pub. Date: Sep. 10, 2015

(54) PERSONAL MOBILITY DEVICE

(71) Applicant: CARY MOORE, Highland, MI (US)

(72) Inventor: CARY MOORE, Highland, MI (US)

(21) Appl. No.: 14/197,269

(22) Filed: Mar. 5, 2014

(51) Int. Cl. A61H 3/00

(52) U.S. Cl. CPC A61H 3/00

(57) ABSTRACT

A personal mobility device that provides upper body support while selectively and controllably rotating a user so that the user may transfer him- or herself from one location to another, comprising a base, a standing platform situated above and in pivotable relation with the base, the standing platform having an upper surface upon which the user stands when using the personal mobility, a drive motor mechanically coupling the base to the standing platform, a handrail assembly mounted to the upper surface of the standing platform supporting one of a pair of hand grips, and a control button located proximate any or each of the pair of hand grips to allow the user to actuate the drive motor and thereby rotate the standing platform relative to the base.

### FIELD OF THE INVENTION

The present invention generally relates to a device for facilitating the mobility of a person with impaired mobility. In particular, a personal mobility device is disclosed that provides upper body support while selectively and controllably rotating a user so that the user may transfer themselves from one location to other.

### BACKGROUND OF THE INVENTION

The mobility of persons having a variety of physical impairments is an important aspect of modern life. Walkers and other similar mobility devices for assisting the elderly and infirm are well-known. Such devices typically include a frame within which the user may stand. Handrails are mounted on the frame to allow the user to lean on and use the frame as a support while walking.

Also, it is known to provide pivoting discs to users who are able to stand but have impaired walking ability. The user stands on the disc, which is then manually rotated, to assist the user to transfer from one location to another, such as from a wheelchair to a bed. However, in using such pivoting discs, it is often difficult for the user to benefit from the device without assistance. Further, even when assistance is available, users of the pivoting discs and their assistants are both recommended to wear a support belt during the transfer process.

Hence, a personal mobility device that provides upper body support while selectively and controllably rotating a user so that the user may transfer him- or herself from one location to another, while also doing so at minimal cost which overcomes these drawbacks, would be advantageous.

### SUMMARY OF THE INVENTION

The present invention provides improved personal mobility between a first location, such as a chair, and a second desired location, such as a wheelchair, for persons suffering from limited impairment but with sufficient upper body strength to assist in their own mobility. The personal mobility device disclosed herein provides such mobility with a device that simultaneously provides upper body support while selectively and controllably rotating a user so that the user may transfer him- or herself from one location to another.

It is therefore an aspect of the present invention to provide a personal mobility device for providing upper body support while selectively and controllably rotating a user so that the user may transfer him- or herself from one location to another, the personal mobility device having a base having an upper surface and a lower surface, the lower surface supporting the personal mobility device, a standing platform situated above and in pivotable relation with the base, the standing platform having an upper surface upon which the user stands when using the personal mobility device and a lower surface facing the upper surface of the base, a drive motor mechanically coupling the base to the standing platform to rotate the standing platform relative to the base, a handrail assembly mounted to the upper surface of the standing platform, the handrail assembly comprising a plurality of vertically extending posts each having a first end attached to the upper surface of the standing platform and a second end supporting one of a pair of hand grips, and a control button located proximate any or each of the pair of hand grips to allow the user to actuate the drive motor and thereby rotate the standing platform relative to the base.

Another aspect of the invention is a personal mobility device where the lower surface of the base has a plurality of wheel assemblies for movably supporting the personal mobility device.

Still another aspect of the present invention is a personal mobility device having a base that is generally circular in shape forming an outer periphery and a set of at least three wheels mounted to the lower surface of the base at substantially regular intervals about the outer periphery of the base.

Yet another aspect of the present invention is a personal mobility device having a set of at least three wheels that are retracted within the base and no longer support the personal mobility device when the user is standing upon the upper surface of the standing platform, and the set of at least three wheels extends beyond the base and upon which the personal mobility device is supported when the user is not standing upon the upper surface of the standing platform.

An additional aspect of the present invention is a personal mobility device where the set of at least three wheels is spring-loaded to extend beyond the base and support the personal mobility device when the user is not standing upon the upper surface of the standing platform.

Another aspect of the present invention is a personal mobility device having a driven shaft mounted to either of the base or the standing platform and the drive motor mounted to the opposite of the base or the standing platform to which the driven shaft is mounted to engage the driven shaft by which the drive motor mechanically couples the base to the standing platform to rotate the standing platform relative to the base.

According to another aspect of the present invention, a personal mobility device has a drive motor and driven shaft mechanically coupled by a drive belt.

A further aspect of the present invention is a personal mobility device where the drive motor and driven shaft are mechanically coupled by a gear assembly comprising a drive gear mounted on the drive motor and a driven gear mounted on the driven shaft of the standing platform.

Yet another aspect of the present invention is a personal mobility device where either of the base or the standing platform further houses a rechargeable battery electrically connected to the drive motor to power the drive motor.

An additional aspect of the present invention is a personal mobility device where the lower surface of the standing platform is supported by the upper surface of the base.

Still another aspect of the present invention is a personal mobility device where each of the base and the standing platform have a generally corresponding circular shape forming an outer periphery and are separated by a set of at least three roller bearing assemblies mounted to either of the upper surface of the base or the lower surface of the standing platform at substantially regular intervals about the outer periphery of the base and the standing platform.

A yet additional aspect of the present invention is a personal mobility device where the set of at least three roller bearing assemblies is mounted to the upper surface of the base and the roller bearings thereof engage a corresponding race provided on the lower surface of the standing platform.

Still another aspect of the present invention is a personal mobility device where the set of at least three roller bearing assemblies is mounted to the lower surface of the standing platform and the roller bearings thereof engage a corresponding race provided on the upper surface of the base.

Yet another aspect of the present invention is a personal mobility device where the standing platform has a generally circular shape forming an outer periphery and the handrail assembly comprises four vertically extending posts each having a first end mounted to the upper surface of the standing platform at substantially regular intervals about the outer periphery of the standing platform and a second end supporting one of a pair of cross-members each upon which the one of a pair of hand grips is mounted.

Another aspect of the present invention is a personal mobility device where the handrail assembly forms a structure having a front side, a right side, and a left side and wherein a fourth side is open so the user can step up onto the standing platform, the hand grips being disposed at a height corresponding approximately to the hand level of the user standing on the standing platform.

A yet additional aspect of the present invention is a personal mobility device where the height of the four vertically extending posts is adjustable so as to adjust the hand grips to a height corresponding approximately to the hand level of the user standing on the standing platform.

A still further aspect of the present invention is a personal mobility device where the handrail assembly further comprises a foldable tray table attached to two of the four vertically extending posts and moveable between a stored position and a deployed position.

Yet another aspect of the present invention is a personal mobility device where the drive control buttons are located on each of the right and left side handrails to rotate the standing platform relative the base in either direction.

Still another aspect of the present invention is a personal mobility device for providing upper body support while selectively and controllably rotating a user so that the user may transfer him- or herself from one location to another, the personal mobility device comprising a base having an upper surface and a lower surface and having a generally circular shape forming an outer periphery, the lower surface supporting the personal mobility device and having a set of at least three wheels mounted to the lower surface of the base at substantially regular intervals about the outer periphery of the base, a standing platform having a generally circular shape forming an outer periphery situated above and in pivotable relation with the base, the standing platform comprising an upper surface upon which the user stands when using the personal mobility device and a lower surface facing the upper surface of the base, wherein the base and the standing platform are separated by a set of at least three roller bearing assemblies mounted to either of the upper surface of the base or the lower surface of the standing platform at substantially regular intervals about the outer periphery of the base and the standing platform, a drive motor mechanically coupling the base to the standing platform to rotate the standing platform relative to the base, the drive motor mounted to either of the upper surface of the base or the lower surface of the standing platform, a handrail assembly comprising four vertically extending posts each having a first end mounted to the upper surface of the standing platform at substantially regular intervals about the outer periphery of the standing platform and a second end supporting one of a pair of cross-members each upon which one of a pair of hand grips is mounted, and a control button located proximate any or each of the pair of hand grips to allow the user to actuate the drive motor and thereby rotate the standing platform relative to the base.

Another aspect of the invention is a method of providing personal mobility to a user so that the user may transfer him- or herself from one location to another through a personal mobility device comprising an upper surface and a lower surface, a standing platform above and in pivotable relation with the base, the standing platform comprising an upper surface upon which the user stands and a lower surface facing the upper surface of the base, a handrail assembly mounted to the upper surface of the standing platform, the handrail assembly comprising a plurality of vertically extending posts each having a first end attached to the upper surface of the standing platform and a second end supporting one of a pair of hand grips, a drive motor mounted to either of the base or standing platform to mechanically couple the base to the standing platform to rotate the standing platform relative to the base, and a control button located proximate any or each of the pair of hand grips to allow the user to actuate the drive motor and thereby rotate the standing platform relative to the base, the method comprising the steps of positioning the personal mobility device to a position between a first location and a second desired location, stepping upon the standing platform while using the handrail assembly for support, actuating the personal mobility device by depressing the control button to rotate the standing platform in the clockwise or counterclockwise direction relative the base, releasing the control button once the proper orientation with the second desired location is obtained, and stepping off the standing platform.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of the personal mobility device in accordance with the present invention;

FIG. 2 is a right side view of the personal mobility device in accordance with the present invention with the tray in the upright, raised position in first direction;

FIG. 3 is a front view of the personal mobility device in accordance with the present invention with the tray in the down, stored position;

FIG. 4 is a right side view of the personal mobility device in accordance with the present invention with the tray in the down, stored position;

FIG. 5 is a right side view of the personal mobility device in accordance with the present invention with the tray in the upright, raised position in both directions;

FIG. 6 is a bottom view of the personal mobility device in accordance with the present invention;

FIG. 7 is a cross-sectional view along the line VII-VII of FIG. 6 of the base and standing platform of the personal mobility device in accordance with the present invention;

FIG. 8 is a cross-sectional view of an alternative attachment of the base to the standing platform;

FIG. 9 is a cross-sectional view of an alternative attachment of the base to the standing platform; and

FIG. 10 is a bottom view the standing platform.

### DETAILED DESCRIPTION OF THE PREFERRED EMBODIMENTS

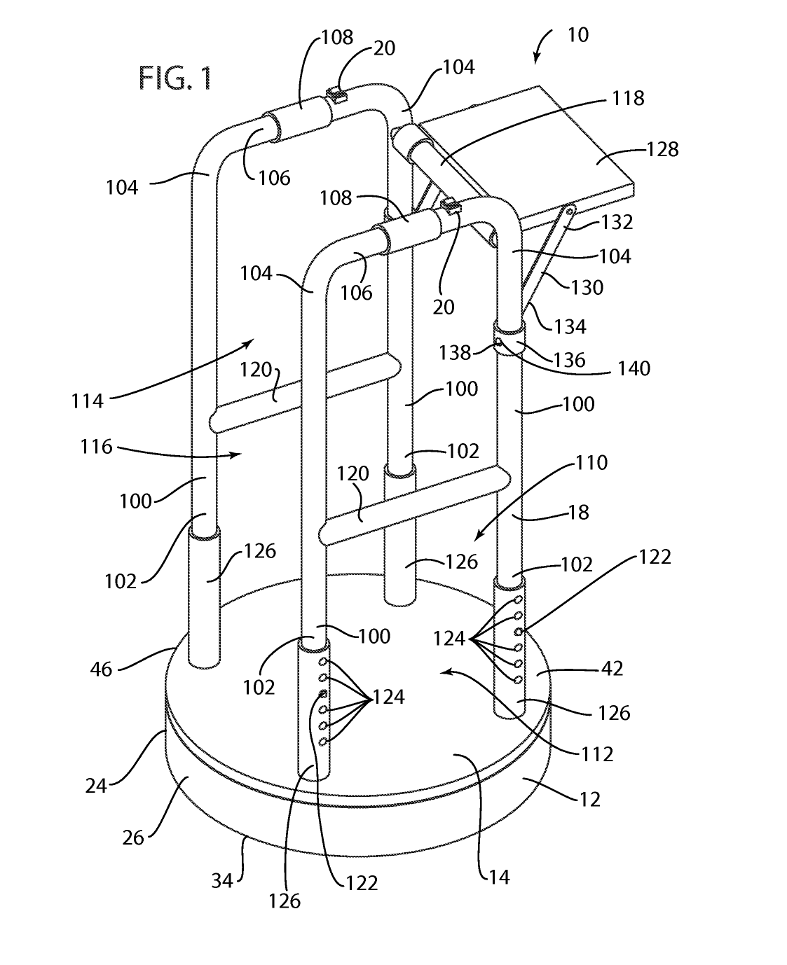

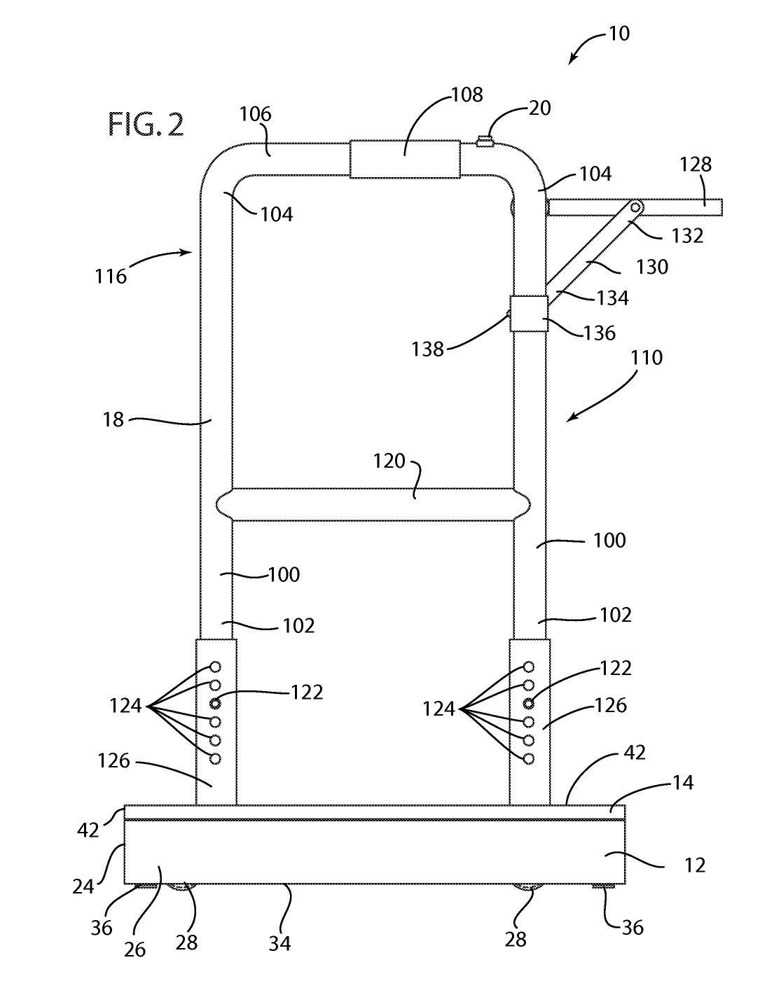

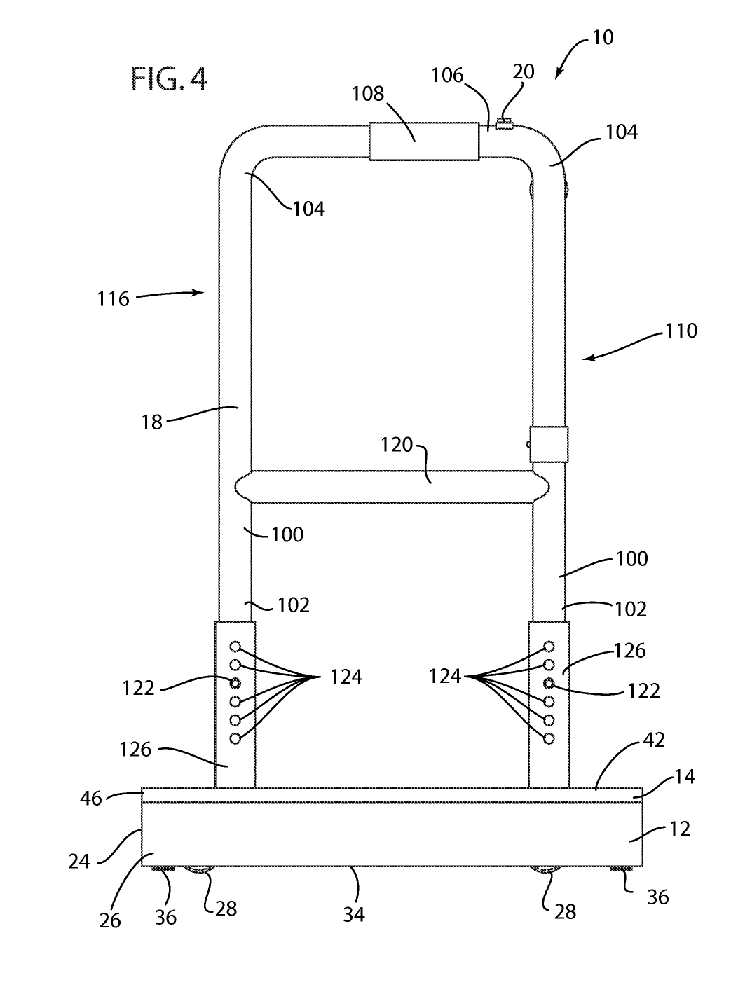

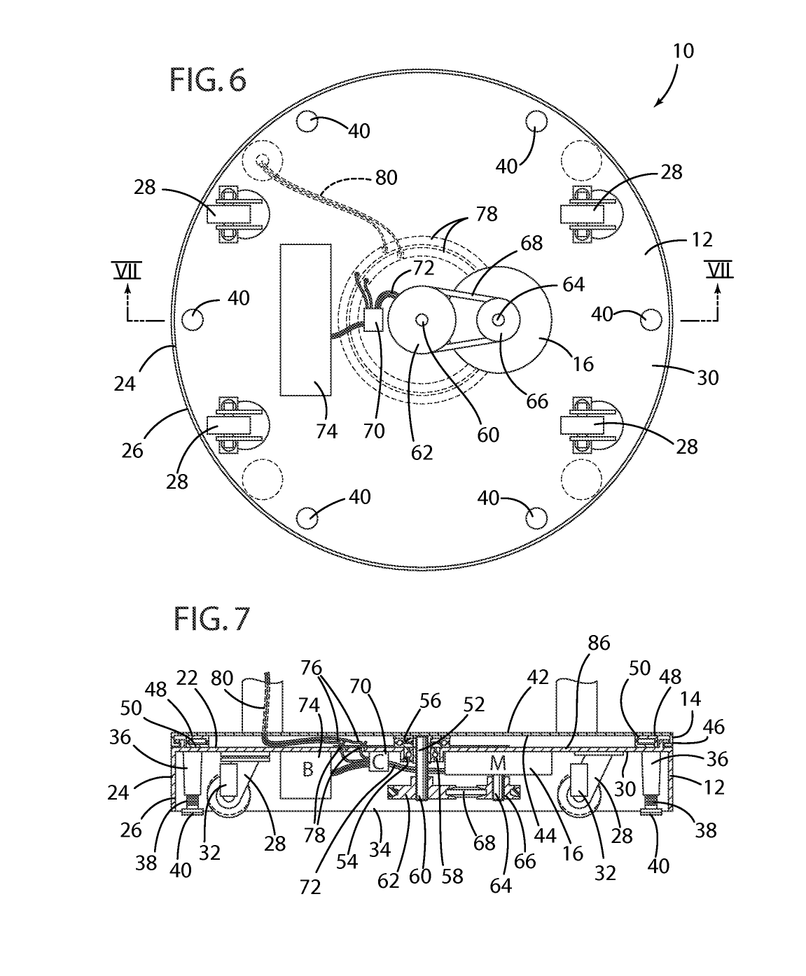

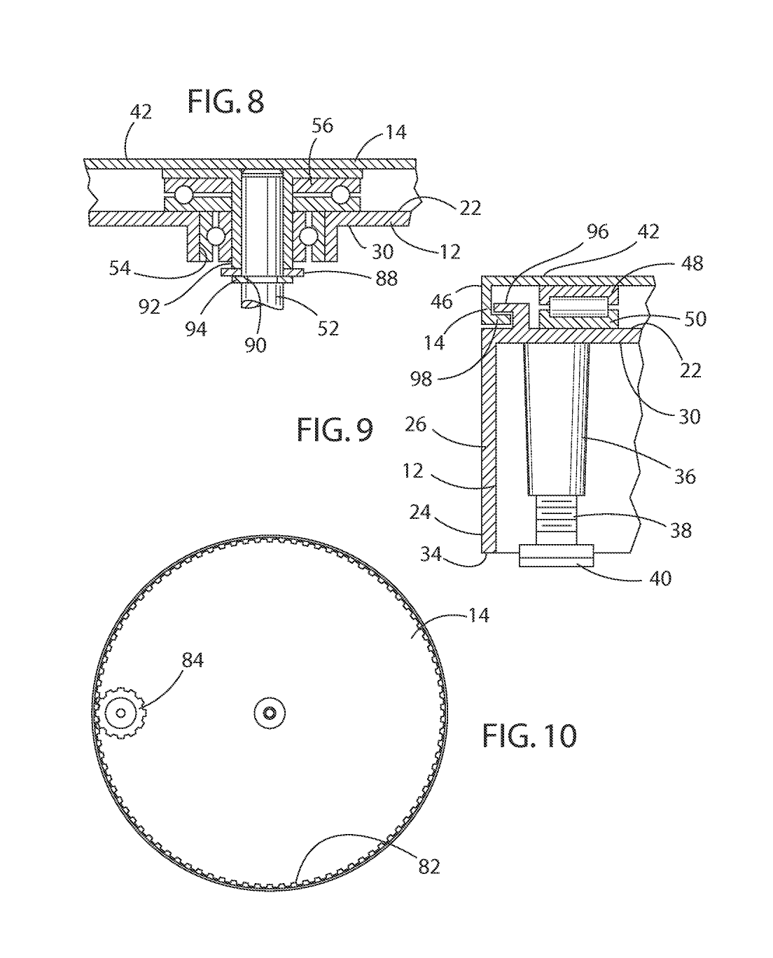

For purposes of description herein, the terms “upper,” “lower,” “right,” “left,” “rear,” “front,” “vertical,” “horizontal,” and derivatives thereof shall relate to the invention as oriented in FIGS. 1-10. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The personal mobility device 10 disclosed herein provides upper body support while selectively and controllably rotating a user so that the user may safely transfer him- or herself from one location to another. As best shown in FIGS. 1-10, the mechanized personal mobility device 10 is intended to assist the safe transfer of mobility challenged individuals from one setting to another with or without the aid of an attendant. The personal mobility device 10 accomplishes these objectives by providing upper body support while selectively and controllably rotating a user so that the user may transfer him- or herself from one location to another.

As shown in the Figures, the personal mobility device 10 primarily comprises a base 12, a standing platform 14, a drive motor 16, a handrail assembly 18, and one or more control buttons 20. The base 12 has a generally circular planar portion 22 forming an outer periphery 24, an annular skirt portion 26 attached to and depending from the planar portion 22, and a set of at least three wheel assemblies 28 mounted to a lower surface 30 of the planar portion 22 of the base 12 at substantially regular intervals about and preferably proximate to the outer periphery 24 of the base 12. Preferably, the wheel assemblies 28 are mounted to the lower surface 30 of the base 12 such that the wheel assemblies 28 extend partially below the annular skirt portion 26 when in the extended position. A spring 32 provided on each wheel assembly 28 urges each of the wheel assemblies 28 to its extended position below a lower edge 34 of the annular skirt portion 26 and thereby allows the wheel assemblies 28 to movably support the personal mobility device 10 when the user is not using the personal mobility device 10.

Thus, when the user is not standing on the standing platform 14, the personal mobility device 10 may be readily rolled upon the wheel assemblies 28 from one location to another as required. However, when the user steps upon the standing platform 14, the weight of the user compresses the springs 32, which are preferably sized to retract with a user weighing at least 50 pounds steps upon the standing platform 14. The wheel assemblies 28 are thus caused to move upward toward the lower surface 30 of the base 12. A plurality of vertically depending support legs 36 is preferably disposed on the lower surface 30 of the planar portion 22 of the base 12 at substantially regular intervals about and proximate to the outer periphery 24 of the base 12. The support legs 36, each slightly shorter in length than the extended wheel assemblies 28, are attached to the lower surface 30 of the base 12 and extend slightly below the lower edge 34 of the annular skirt portion 26. Thus, as the wheel assemblies 28 are forced upwardly toward the lower surface 30 of the base 12, the support legs 36 are simultaneously brought into contact with the ground or floor surface upon which the personal mobility device 10 is to be used. When the user steps off of the standing platform 14, the removal of the weight of the user causes the springs 32 to expand, thereby urging the wheel assemblies 28 to extend beyond the support legs 36 and the lower edge 34 of the annular skirt portion 26 of base 12 and thereby again movably support the personal mobility device 10. Preferably, the distal end 38 of each of the support legs 36 in contact the ground or floor surface are provided with non-skid pads 40 so that the base 12 is firmly positioned from further movement when in use.

As shown, preferably four wheel assemblies 28 are mounted to the lower surface 30 of the base 12 at substantially regular intervals about and proximate to the outer periphery 24 of the base 12 to more evenly distribute the weight of the user and provide a more stable platform. Indeed, five or more wheel assemblies 28 may be used, but suffer from the penalty of cost. However, as noted above, at least three wheel assemblies 28 may be used. Further, other configurations for the wheel assemblies 28 can be envisioned that would selectively support the base 12 as described above.

The standing platform 14 is situated above and is in pivotable relation with the base 12. The standing platform 14 has an upper surface 42 upon which the user stands when using the personal mobility device 10 and a lower surface 44. The lower surface 44 of the standing platform 14 faces and is preferably supported by the upper surface 30 of the base 12. The standing platform 14 preferably has a generally circular shape forming an outer periphery 46 corresponding to the base 12 and is preferably separated from the base 12 by a set of at least three roller bearing assemblies 48 mounted to either of the upper surface 30 of the base 12 or the lower surface 44 of the standing platform 14 at substantially regular intervals about and proximate to the outer peripheries 24, 44 of the base 12 and the standing platform 14, respectively. The roller bearing assemblies 48 are preferably mounted to the upper surface 30 of the base 12, and the roller bearings 48 thereof engage a corresponding race 50 provided on the lower surface 44 of the standing platform 14. However, it is contemplated that this mounting arrangement may be reversed. Further, it is contemplated that a low friction pad (not shown) could be adapted to separate the standing platform 14 and the base 12 and support the standing platform 14 as it is rotated, as will be further described below. Most importantly, however, is that the supporting interface between the standing platform 14 and the base 12 allow the standing platform 14 to freely spin relative the base 12 and provide stability for the overall personal mobility device 10.

The standing platform 14 further preferably includes a driven shaft 52 mounted concentrically to and depending from the lower surface 44 of the standing platform 14 to below the lower surface 30 of the base 12 through an opening 54 in the base 12. In this arrangement, a vertically loaded ball bearing assembly 56 disposed about the driven shaft 52 proximate the lower surface 44 of the standing platform 14 provides additional stability. Similarly, stability is provided by a horizontally loaded ball bearing assembly 58 disposed about the driven shaft 52 and within the opening 54 in the base 12 through which the driven shaft 52 depends.

The driven shaft 52 preferably terminates at a distal end 60 whereat a driven pulley 62 is fixed. The low RPM direct current electric drive motor 16 is preferably mounted to the lower surface 30 of the base 12 adjacent the driven shaft 52. The output shaft 64 of the drive motor preferably and similarly terminates in drive pulley 66. A drive belt 68 about each of the drive pulley 66 and driven pulley 62 mechanically couples the base 12 to the standing platform 14 to rotate the standing platform 14 relative to the base 12 when the drive motor 16 is actuated. A control module 70 is preferably provided to selectively interconnect the drive motor 16 with a power source via electrical wiring 72. Preferably, the power source is a rechargeable battery 74 mounted to the lower surface 30 of the base 12. A rotatable coupler 76 is mounted on the standing platform 14 and engages a corresponding pair of contact rings 78 mounted on the base 12 for electric transmission of a control signal from the control wiring 80, as discussed further below.

As noted above, the driven shaft 52 is preferably mounted to the standing platform 14. However, it is contemplated that this arrangement can be reversed and that the driven shaft 52 can be mounted to either of the base 12 or the standing platform 14 and the drive motor 16 mounted to the opposite of the base 12 or the standing platform 14 to which the driven shaft 52 is mounted so as to mechanically couple the base 12 to the standing platform 14 to rotate the standing platform 14 relative to the base 12. Also, the drive belt 68 and pulleys 62, 66, can be replaced by a gear assembly comprising a drive gear mounted on the drive motor 16 and a driven gear mounted on the driven shaft 52 of the standing platform 14. Alternatively, a ring gear 82 can be mounted to the lower surface 30 of the standing platform 14 proximate its periphery 46 or mounted to an upper surface 86 of the base 12 proximate its periphery 24, with a corresponding pinion gear 84 mounted to the opposite of the standing platform 14 or base 12 to which the ring gear 82 is attached, the pinion gear 84 engaging the gear ring 82 to rotate the standing platform 14 relative to the base 12.

Preferably, the standing platform 14 and the base 12 are mechanically coupled to one another. For example, a retaining ring 88 can be installed about a notch 90 provided on the driven shaft 52, where the retaining ring 88 extends outwardly to engage a flange 92 located on and depending from the lower surface 30 of the base 12 and whereat a lock ring 94 within the notch 90 secures the retaining ring 88 in position. Alternatively, a plurality of tabs 96 can be provided on the upper surface 86 of the base 12 at regular intervals to and proximate its periphery 24 that engage a lip 98 depending from the lower surface 30 of the standing platform 14 proximate its periphery 46 and extending inwardly.

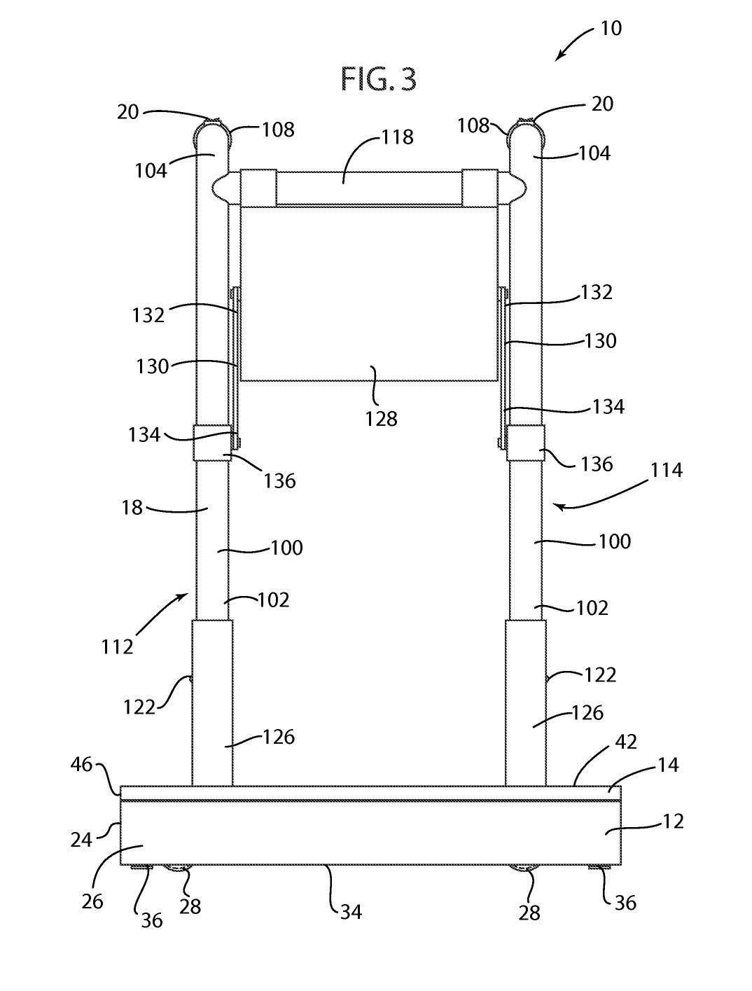

The handrail assembly 18 is mounted to the upper surface 42 of the standing platform 14, as shown in the Figures. The handrail assembly 18 preferably comprises four vertically extending aluminum posts 100, each having a first end 102 mounted to the upper surface 42 of the standing platform 14 at substantially regular intervals about and proximate to the outer periphery 46 of the standing platform 14. A second end 104 of the posts 100 is attached to and supports one of a pair of cross-members 106 each upon which the one of a pair of hand grips 108 is mounted. The handrail assembly 18 thus forms a structure having a front side 110, a right side 112, and a left side 114. A fourth side 116 is open so the user can step up onto the standing platform 14. A front reinforcing brace 118 preferably extends between the front two posts 100, as shown in FIGS. 1 and 3. Further, a pair of side reinforcing braces 120 is preferably mounted approximately midway along the height of the posts 100 on each of the right and left sides 112, 114, respectively.

The hand grips 108 are preferably composed of an elastomeric material so as to be firmly and securely gripped by the user and disposed at a height corresponding approximately to the hand level of the user standing on the standing platform 14. Preferably, the height of each of the four vertically extending posts 100 is adjustable via a retractable pin 122 mounted on the post 100 and cooperating series of vertical detents or holes 124 on an aluminum sleeve 126 mounted on the upper surface 42 of the standing platform 14 that receives the first end 102 of each of the posts 100. Thus, the hand grips 108 may be readily adjusted to a height corresponding approximately to the hand level of the user standing on the standing platform 14.

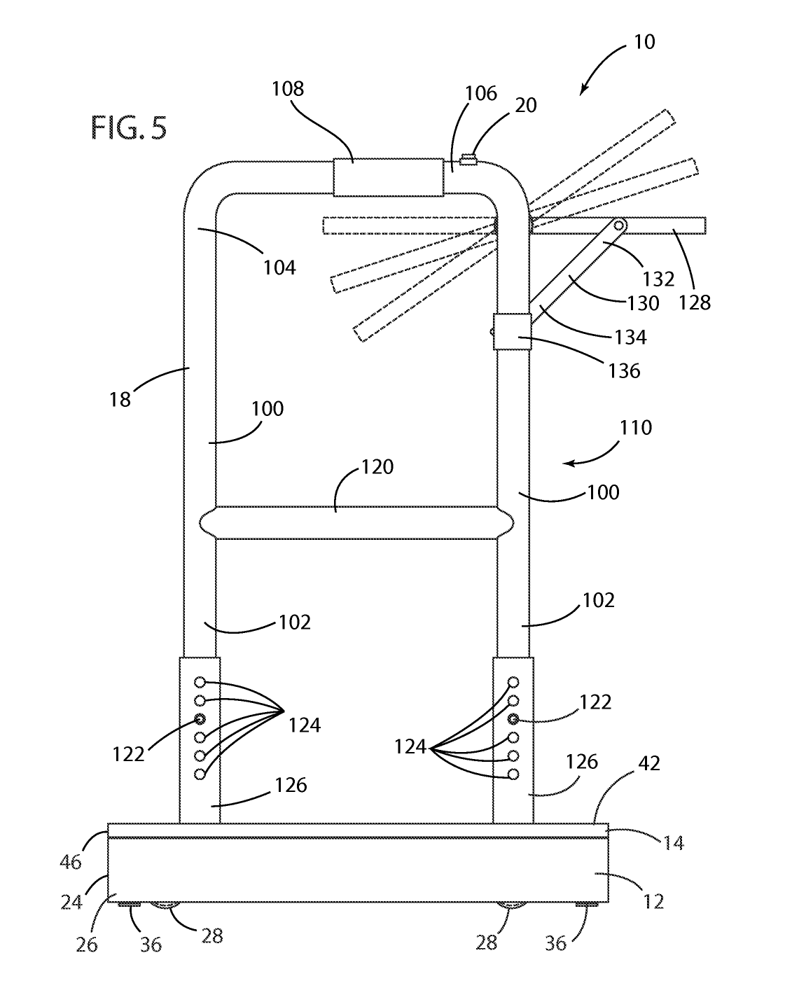

Preferably, the handrail assembly 18 further includes a foldable tray table 128 attached to the front two of the four vertically extending posts 100 and moveable between a stored position and a pair of deployed positions. The tray 128 includes a pair of movable support arms 130 each pivotably connected to the tray 128 at one end 132 and pivotably connected to a slidable collar 136 on one of the front posts 100 at the opposite end 134. The slidable collars 136 are secured via a retractable pin 138 mounted on the post 100 and a single cooperating detent or hole 140 in the slidable collar 136 to lock the tray 128 in one of two upright, raised positions, as best shown in FIG. 5. In the first raised, upright position, the tray 128 extends forward, as shown. In a second raised, upright position, the tray 128 extends rearward toward the user.

At least one control button 20 is located proximate one of the pair of hand grips 108 to allow the user to actuate the drive motor 16 and thereby rotate the standing platform 14 relative to the base 12. Preferably, a control button 20 is provided proximate each of the hand grips 108 to rotate the standing platform 14 relative the base 12 in either direction. The control buttons 20 are electrically coupled with the control module 70 via control wiring 80 extending upwardly from the standing platform 14 through an opening 142 and through one of the posts 100 and front brace to the control buttons 20. Preferably, the control buttons 20 each are of a toggle configuration and initiates rotation of the standing platform 14 in either direction by pushing on opposite sides of the control buttons 20, where the middle position corresponds to the off position.

In operation, a user of the personal mobility device simply rolls the device 10 to a position between a first location and a second desired location, such as between a wheelchair and a bed, wherein the user can step though the open side 116 and upon the standing platform 14, while the user supports him- or herself on the handrail assembly 18. By so doing, the wheel assemblies 28 are retracted and the device 10 then becomes supported on the support legs 36. The device 10 is actuated by the user simply depressing the control button 20 to rotate the standing platform 14 in the clockwise or counterclockwise direction as required. Once the proper orientation with the second desired location is obtained, the control button 20 is released and the device again becomes stationary. The user need then only step off the standing platform 14 and rest upon the second desired location.

The present invention thus provides improved personal mobility between a first location, such as a chair, and a second desired location, such as a wheelchair, for persons suffering from limited impairment but with sufficient upper body strength to assist in their own mobility. The personal mobility device 10 disclosed herein provides such mobility with a device 10 that simultaneously provides upper body support while selectively and controllably rotating a user so that the user may transfer him- or herself from one location to another.

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. A personal mobility device for providing upper body support while selectively and controllably rotating a user so that the user may transfer him- or herself from one location to another, the personal mobility device comprising:
a base comprising an upper surface and a lower surface, the lower surface supporting the personal mobility device;
a standing platform situated above and in pivotable relation with the base, the standing platform comprising an upper surface upon which the user stands when using the personal mobility device and a lower surface, the lower surface of the standing platform facing the upper surface of the base;
a drive motor mechanically coupling the base to the standing platform to rotate the standing platform relative to the base;
a handrail assembly mounted to the upper surface of the standing platform, the handrail assembly comprising a plurality of vertically extending posts each having a first end attached to the upper surface of the standing platform and a second end supporting one of a pair of hand grips; and
a control button located proximate any or each of the pair of hand grips to allow the user to actuate the drive motor and thereby rotate the standing platform relative to the base.

2. The personal mobility device of claim 1, wherein the lower surface of the base has a plurality of wheel assemblies for movably supporting the personal mobility device.

3. The personal mobility device of claim 1, wherein the base has a generally circular shape forming an outer periphery and a set of at least three wheels is mounted to the lower surface of the base at substantially regular intervals about the outer periphery of the base.

4. The personal mobility device of claim 3, wherein the set of at least three wheels is retracted toward the base and no longer supports the personal mobility device when the user is standing upon the upper surface of the standing platform and the set of at least three wheels is extended beyond the base and upon which the personal mobility device is supported when the user is not standing upon the upper surface of the standing platform.

5. The personal mobility device of claim 4, wherein the set of at least three wheels is spring loaded to extend beyond the base and support the personal mobility device when the user is not standing upon the upper surface of the standing platform.

6. The personal mobility device of claim 1, wherein a driven shaft is mounted to either of the base or the standing platform and the drive motor is mounted to the opposite of the base or the standing platform to which the driven shaft is mounted to engage the driven shaft by which the drive motor mechanically couples the base to the standing platform to rotate the standing platform relative to the base.

7. The personal mobility device of claim 6, wherein the drive motor and driven shaft of the standing platform are mechanically coupled by a drive belt.

8. The personal mobility device of claim 6, wherein the drive motor and driven shaft are mechanically coupled by a gear assembly comprising a drive gear mounted on the drive motor and a driven gear mounted on the driven shaft of the standing platform.

9. The personal mobility device of claim 6, further comprising a rechargeable battery electrically connected to the drive motor to power the drive motor.

10. The personal mobility device of claim 1, wherein the lower surface of the standing platform is supported by the upper surface of the base.

11. The personal mobility device of claim 1, wherein each of the base and the standing platform have a generally corresponding circular shape forming an outer periphery and are separated by a set of at least three roller bearing assemblies mounted to either of the upper surface of the base or the lower surface of the standing platform at substantially regular intervals about the outer periphery of the base and the standing platform.

12. The personal mobility device of claim 11, wherein the set of at least three roller bearing assemblies is mounted to the upper surface of the base and the roller bearings thereof engage a corresponding race provided on the lower surface of the standing platform.

13. The personal mobility device of claim 11, wherein the set of at least three roller bearing assemblies is mounted to the lower surface of the standing platform and the roller bearings thereof engage a corresponding race provided on the upper surface of the base.

14. The personal mobility device of claim 1, wherein the standing platform has a generally circular shape forming an outer periphery and the handrail assembly comprises four vertically extending posts each having a first end mounted to the upper surface of the standing platform at substantially regular intervals about the outer periphery of the standing platform and a second end supporting one of a pair of cross-members each upon which the one of a pair of hand grips is mounted.

15. The personal mobility device of claim 14, wherein the handrail assembly forms a structure having a front side, a right side, and a left side and wherein a fourth side is open so the user can step up onto the standing platform, the hand grips being disposed at a height corresponding approximately to the hand level of the user standing on the standing platform.

16. The personal mobility device of claim 14, wherein the height of the four vertically extending posts is adjustable so as to adjust the hand grips to a height corresponding approximately to the hand level of the user standing on the standing platform.

17. The personal mobility device of claim 14, wherein the handrail assembly further comprises a foldable tray table attached to two of the four vertically extending posts and moveable between a stored position and a deployed position.

18. The personal mobility device of claim 1, wherein the drive control buttons are located on each of the left and right side handrails to rotate the standing platform relative the base in either direction.

19. A personal mobility device for providing upper body support while selectively and controllably rotating a user so that the user may transfer him- or herself from one location to another, the personal mobility device comprising:
a base comprising an upper surface and a lower surface and having a generally circular shape forming an outer periphery, the lower surface supporting the personal mobility device and having a set of at least three wheels mounted to the lower surface of the base at substantially regular intervals about the outer periphery of the base;
a standing platform having a generally circular shape forming an outer periphery situated above and in pivotable relation with the base, the standing platform comprising an upper surface upon which the user stands when using the personal mobility device and a lower surface, the lower surface of the standing platform facing the upper surface of the base, wherein the base and the standing platform are separated by a set of at least three roller bearing assemblies mounted to either of the upper surface of the base or the lower surface of the standing platform at substantially regular intervals about the outer periphery of the base and the standing platform;
a drive motor mechanically coupling the base to the standing platform to rotate the standing platform relative to the base, the drive motor mounted to either of the upper surface of the base or the lower surface of the standing platform;
a handrail assembly comprising four vertically extending posts each having a first end mounted to the upper surface of the standing platform at substantially regular intervals about the outer periphery of the standing platform and a second end supporting one of a pair of cross-members each upon which one of a pair of hand grips is mounted; and
a control button located proximate any or each of the pair of hand grips to allow the user to actuate the drive motor and thereby rotate the standing platform relative to the base.

20. A method of providing personal mobility to a user so that the user may transfer him- or herself from one location to another through a personal mobility device comprising an upper surface and a lower surface, a standing platform above and in pivotable relation with the base, the standing platform comprising an upper surface upon which the user stands and a lower surface, the lower surface of the standing platform facing the upper surface of the base, a handrail assembly mounted to the upper surface of the standing platform, the handrail assembly comprising a plurality of vertically extending posts each having a first end attached to the upper surface of the standing platform and a second end supporting one of a pair of hand grips, a drive motor mounted to either of the base or standing platform to mechanically couple the base to the standing platform to rotate the standing platform relative to the base, and a control button located proximate any or each of the pair of hand grips to allow the user to actuate the drive motor and thereby rotate the standing platform relative to the base, the method comprising the steps of;
positioning the personal mobility device to a position between a first location and a second desired location;
stepping upon the standing platform while using the handrail assembly for support;
actuating the personal mobility device by depressing the control button to rotate the standing platform in the clockwise or counterclockwise direction relative the base;
releasing the control button once the proper orientation with the second desired location is obtained; and
stepping off the standing platform.
